(19) United States
(12) Patent Application Publication
(10) Pub. No.: US 2022/0181695 A1
(43) Pub. Date: Jun. 9, 2022

(54) NON-AQUEOUS ELECTROLYTE SECONDARY BATTERY

(71) Applicant: Panasonic Intellectual Property Management Co., Ltd., Osaka-shi, Osaka (JP)

(72) Inventors: Akira Kano, Osaka (JP); Tomohisa Okazaki, Osaka (JP); Ryohei Miyamae, Osaka (JP)

(73) Assignee: Panasonic Intellectual Property Management Co., Ltd., Osaka-shi, Osaka (JP)

(21) Appl. No.: 17/442,360

(22) PCT Filed: Feb. 17, 2020
(86) PCT No.: PCT/JP2020/006125

§ 371 Date: Sep. 23, 2021

(30) Foreign Application Priority Data
Mar. 29, 2019 (JP) 2019-066976

(51) Int. Cl. H01M 10/0569; H01M 10/0525

(52) U.S. Cl. CPC H01M 10/0569; H01M 2300/0034; H01M 10/0525

(57) ABSTRACT

In a non-aqueous electrolyte secondary battery including a positive electrode, a negative electrode, and a non-aqueous electrolyte having lithium-ion conductivity, the solvent in the non-aqueous electrolyte includes a first ether compound represented by a general formula (1): R1-(OCH₂CH₂)ₙ—OR₂ in which R1 and R2 are independently an alkyl group with a carbon number of 1 to 5, and n represents 1 to 3; and a second ether compound having a fluorination rate of 60% or more and represented by a general formula (2): Cₐ₁M_{b1}F_{c1}O_{d1}(CF₂OCH₂)Ca₂Hb₂F_{c2}O_{d2} in which a1≥1, a2≥0, b1≤2a1, b2≤2a2, c1=(2a1+1)−b1, c2=(2a2+1)−b2, d≥0, and d2≥0. The proportion of a total amount of the first ether compound and the second ether compound in the solvent is 80 volume % or more.

### TECHNICAL FIELD

The present invention relates to a non-aqueous electrolyte secondary battery using a lithium metal as a negative electrode active material, and more particularly, to improvement of a non-aqueous electrolyte.

### BACKGROUND ART

Non-aqueous electrolyte secondary batteries have been used for applications such as ICTs (Information and Communication Technology) such as PCs and smartphones, for vehicle-bearing applications, and power storage applications. In such applications, non-aqueous electrolyte secondary batteries require further high capacity. Lithium-ion batteries have been known as high-capacity non-aqueous electrolyte secondary batteries. High capacity of lithium-ion batteries can be achieved by combining a negative electrode active material, e.g., graphite with an alloy active material such as a silicon compound.

Regarding lithium-ion batteries, various studies have been conducted on a non-aqueous electrolyte, including an electrolytic salt and a solvent, in order to improve battery properties such as cycle characteristics.

For example, Patent Literature 1 proposes a non-aqueous liquid electrolyte containing a fluorine-containing solvent, a cyclic carboxylic acid ester compound, a saturated cyclic carbonate compound, and a lithium salt having a specific structure.

In Patent Literature 2, in a secondary battery using carbon as a negative electrode active material and a sulfur-based electrode active material as a positive electrode active material, it has been proposed to use a liquid electrolyte containing a solvated ionic liquid in which an ether and a lithium salt form a complex, and a hydrofluoroether.

In Patent Literature 3, a non-aqueous liquid electrolyte containing a hydrofluoroether having a specific structure, a chain ether, a chain carbonate, and a lithium salt having a specific structure is used.

However, enhancement in capacity of lithium-ion batteries is reaching the limit. Therefore, a lithium secondary battery has appeared to be promising as a high-capacity non-aqueous electrolyte secondary battery beyond lithium-ion batteries. In a lithium secondary battery, at the time of charging, a lithium metal deposits on the negative electrode, and the lithium metal dissolves in the non-aqueous electrolyte during discharging. This deposition and dissolution of lithium metal play roles of charge and discharge. Lithium secondary batteries can also be referred to as lithium metal secondary batteries.

### CITATION LIST

### Patent Literature

[PTL 1] Japanese Laid-Open Patent Publication No. 2017-107639
[PTL 2] Japanese Laid-Open Patent Publication No. 2014-112526
[PTL 3] Japanese Laid-Open Patent Publication No. 2001-93572

### SUMMARY OF INVENTION

### Technical Problem

However, it is not easy to improve the cycle characteristics of non-aqueous electrolyte secondaries even if a non-aqueous electrolyte suitable for a lithium-ion battery is adopted in a non-aqueous electrolyte secondary battery using a lithium metal as a negative electrode active material.

### Solution to Problem

One aspect of the present disclosure relates to a non-aqueous electrolyte secondary battery comprising: a positive electrode, a negative electrode and a non-aqueous electrolyte with lithium-ion conductivity, wherein, on the negative electrode, a lithium metal is deposited by charging and the lithium metal is dissolved in the non-aqueous electrolyte by discharging, the non-aqueous electrolyte includes an electrolytic salt and a solvent, the solvent includes a first ether compound represented by a general formula (1): R1-(OCH₂CH₂)ₙ—OR2, where R1 and R2 are independently an alkyl group with a carbon number of 1 to 5, and n represents 1 to 3, and a second ether compound having a fluorination rate of 60% or more and represented by a general formula (2): Cₐ₁H_{b1}F_{c1}O_{d1}(CF₂OCH₂)Ca₂Hb₂F_{c2}O_{d2}, where a1≥1, a2≥0, b1≤2a1, b2≤2a2, c1=(2a1+1)−b1, c2=(2a2+1)−b2, d1≥0, and d2≥0, and a proportion of a total amount of the first ether compound and the second ether compound in the solvent is 80 volume % or more.

### Advantageous Effects of Invention

According to the present invention, in a non-aqueous electrolyte secondary battery using a lithium metal as a negative electrode active material (hereinafter, referred to as a lithium metal secondary battery), cycle characteristics can be improved.

While the novel features of the invention are set forth in the appended claims, the invention relates both to configuration and content and will be better understood by the following detailed description taken in conjunction with other objects and features of the invention and collating the drawings.

### BRIEF DESCRIPTION OF DRAWINGS

FIG. 1 A schematical longitudinal sectional view of a lithium metal secondary battery according to one embodiment of the present disclosure.

FIG. 2 A schematical enlarged sectional view of the region II of a fully discharged state of the lithium metal secondary battery.

FIG. 3 A schematical enlarged sectional view of the region II of a charged state of the lithium metal secondary battery.

### DESCRIPTION OF EMBODIMENTS

A non-aqueous electrolyte secondary battery according to an embodiment of the invention relates to a so-called lithium metal secondary battery, which comprises a positive electrode, a negative electrode, and a non-aqueous electrolyte with lithium-ion conductivity. On the negative electrode, a lithium metal is deposited by charging, and the lithium metal is dissolved into the non-aqueous electrolyte by discharging. In a lithium metal secondary battery, for example, more than 50%, even more than 80%, or substantially 100% of the reversible capacity is produced due to the deposition and dissolution of the lithium metal.

In a lithium metal secondary battery, a lithium metal is almost usually present on the negative electrode. Since a lithium metal has extremely high reductivity, it tends to cause side reactions with the non-aqueous electrolyte. In addition, on the negative electrode, at the time of charging, an SEI (Solid Electrolyte Interphase) film is formed by decomposition and/or reaction of components contained in the non-aqueous electrolyte. In a lithium metal secondary battery, deposition of a lithium metal progresses in parallel with the formation of an SEI film, leading to uneven thickness of the SEI film and uneven charge reaction. When a charge reaction proceeds unevenly, a lithium metal can locally deposit in a dendritic form, and a portion of the lithium metal can be isolated, as well as the surface area of the lithium metal increases and side reactions involving the non-aqueous electrolyte further increase. As a result, reduction in discharge capacity becomes pronounced and cycle characteristics can be deteriorated.

Further, in a lithium metal secondary battery, since the charging and discharging is performed by deposition and dissolution of a lithium metal on the negative electrode, volume change of the negative electrode associated with charging and discharging is particularly remarkable. When the negative electrode expands at the time of charging, an electrode group containing the positive and the negative electrodes can expand. When a lithium metal is unevenly deposited in a dendritic form, the amount of expansion of the electrode group is increased, and due to the influence of the stress generated at that time, cracks may occur in the electrodes, or the electrodes may be cut. Damage to such electrodes can also result in a significant decrease in cycle characteristics.

Accordingly, it is desirable to suppress side reactions of a lithium metal with a non-aqueous electrolyte and to suppress deposition of a lithium metal in a dendritic form in order to improve cycle characteristics of the lithium metal secondary battery.

Here, the non-aqueous electrolyte includes an electrolytic salt and a solvent, and the solvent includes a first ether compound represented by the general formula (1): R1-(OCH₂CH₂)ₙ—OR₂ where R1 and R2 are independently an alkyl group with a carbon number of 1 to 5 and n represents 1 to 3.

The LUMO (Lowest Unoccupied Molecular Orbital) of the ether resides at a higher energy level. Therefore, the ether is hardly reduced and decomposed even when contacted with a lithium metal having a strong reductivity. Further, since oxygen in the ether skeleton strongly interacts with lithium ions, the lithium salt contained as an electrolytic salt in the non-aqueous electrolyte can be easily dissolved.

It is considered that the first ether compound is suitable as a solvent for a non-aqueous electrolyte of a lithium metal secondary battery in terms of suppressing side reactions between a lithium metal and the non-aqueous electrolyte and enhancing solubility of a lithium salt in the solvent. However, in practice, when only the first ether compound is used as the solvent, the charge and discharge reactions become uneven and cycle characteristics deteriorate. This is considered to be due to the fact that the interaction between the first ether compound and lithium ions is too strong and the energy necessary for desolvation of the ether with lithium ions increases.

When the desolvation energy of the ether is large, lithium ions are captured by the ether molecules, and lithium ions are hardly reduced to a lithium metal on the surface of the negative electrode. In such conditions, once a lithium metal is locally deposited on the negative electrode surface, variations in thickness of the SEI film is likely to occur. Therefore, the charge reaction is considered to proceed unevenly on the negative electrode as a whole. In addition, a lithium metal is easy to deposit in a dendritic form, because local parts in which the charge reaction preferentially occurs can be produced. Due to the formation of a dendritic lithium metal, side reactions are more accelerated, and the charge and discharge reactions proceed even more unevenly.

On the other hand, when the following second ether compound is used together with the first ether compound as the solvent of the non-aqueous electrolyte, the charge and discharge reactions proceed more uniformly in the lithium metal secondary battery.

The second ether compound is a fluorinated ether compound with a fluorination rate of 60% or more represented by the general formula (2): Cₐ₁H_{b1}F_{c1}O_{d1}(CF₂OCH₂)Ca₂Hb₂F_{c2}O_{d2} where a1≥1, a2≥0, b1≤2a1, b2≤2a2, c1=(2a1+1)−b1, c2=(2a2+1)−b2, d1≥0, and d2≥0.

By using the second ether compound, the interaction of oxygen in the ether skeleton with lithium ions can be reduced. The fluorine atom contained in the second ether compound has a function of attracting electrons of the whole molecule of the second ether compound to the inner shell side due to its strong electronegativity. The introduction of fluorine into the ether lowers the orbital level of the lone pair of electrons of oxygen in the ether skeleton, which should otherwise interact with lithium ions. Reduced overlap of the orbitals weaken the interaction between lithium ions and the ethers. Since lithium ions are hardly trapped by the second ether compound, lithium ions are easily reduced to lithium metals on the surface of the negative electrode. Thus, even though lithium metals are deposited on the negative electrode during charging, a more uniform SEI film can be formed and the formation of a dendritic lithium metal can be inhibited. Therefore, side reactions between lithium metals and the non-aqueous electrolyte are suppressed, so that the charge and discharge reactions proceed more uniformly.

When a uniform SEI film is formed, side reactions between lithium metals and the non-aqueous electrolyte are suppressed, and more uniform charge and discharge reactions proceed, deposition of a dendritic lithium metal is also suppressed, and a volume change due to expansion and contraction of the electrode group is also suppressed.

Note that, in the present disclosure, the fluorination rate of the second ether compound is expressed as a percentage (%) of the fluorine atom number in the total number of the fluorine atom and the hydrogen atom included in the second ether compound. Therefore, the fluorination rate has the same meaning as the value of the percentage (%) of the substitution of the hydrogen atom by the fluorine atom in a tentative ether formed by replacing each fluorine atom of the second ether compound with a hydrogen atom.

The proportion of the total amount of the first ether compound and the second ether compound in the solvent is 80 volume % or more. When the proportion of the total amount is less than 80 volume %, the aforementioned effects are less likely to be obtained, making it difficult to improve cycle characteristics of the non-aqueous electrolyte secondary battery.

Configurations of a non-aqueous electrolyte secondary battery according to an embodiment of the present invention is described in more detail below.

### [Non-Aqueous Electrolyte]

As a non-aqueous electrolyte, one having lithium-ion conductivity is used. The non-aqueous electrolyte includes an electrolytic salt and a solvent. As the solvent, a non-aqueous solvent is used. As the electrolytic salt, a lithium salt is used. The non-aqueous electrolyte may be in a liquid state or in a gel state. A liquid non-aqueous electrolyte is prepared by dissolving an electrolytic salt in a solvent.

The non-aqueous electrolyte in a gel state includes a liquid non-aqueous electrolyte (non-aqueous electrolytic solution) and a matrix polymer. As the matrix polymer, for example, a polymer material which absorbs a solvent and forms a gel is used. Examples of such a polymer material include a fluororesin, an acrylic resin, and/or a polyether resin.

The solvent includes the first ether compound and the second ether compound. Note that the solvent may contain a solvent other than the first ether compound and the second ether compound.

### (Solvent)

The first ether compound is a chain ether compound represented by the general formula (1): R1-(OCH₂CH₂)ₙ—OR₂.

In the formula (1), R1 and R2 are each independently an alkyl group with a carbon number of 1 to 5, and preferably an alkyl group with a carbon number of 1 to 2. Also, n represents 1 to 3, and preferably 1 to 2. When R 1, R2 and n are in the above range, a moderate interaction of oxygen and lithium ions in the first ether compound is obtained, so that the solubility of the lithium salt in the non-aqueous electrolyte is increased. At the same time, high fluidity and high lithium-ion conductivity of the non-aqueous electrolyte can be also ensured.

Specific examples of the first ether compound include 1,2-dimethoxyethane, 1,2-diethoxyethane, 1,2-dibutoxyethane, diethylene glycol dimethyl ether, diethylene glycol diethyl ether, diethylene glycol ethyl methyl ether, diethylene glycol dibutyl ether, triethylene glycol dimethyl ether, and the like. The first ether compound may be used singly or in combination of two or more kinds.

The second ether compound is a fluorinated ether compound represented by the general formula (2): Cₐ₁H_{b1}F_{c1}O_{d1}(CF₂OCH₂)Ca₂Hb₂F_{c2}O_{d2}.

The formula (2) satisfies a1≥1, a2≥0, b1≤2a1, b2≤2a2, c1=(2a1+1)−b1, c2=(2a2+1)−b2, d1≥0, and d2≥0. Further, the fluorination rate of the second ether compound is 60% or more, and preferably 65% or more. When a1, a2, b1, b2, c1, c2, d1, d2 and the fluorination rate satisfy the above range, the interaction between and lithium ions and oxygen in the second ether compound is weakened, so that lithium ions tend to be reduced to lithium metals on the negative electrode, and a more uniform SEI film can be formed. High fluidity and high lithium-ion conductivity of the non-aqueous electrolyte can also be ensured. Further, it is possible to suppress the oxidative decomposition reaction of the first ether compound which may occur at the interface between the positive electrode and the non-aqueous electrolyte and to protect the positive electrode. It is considered that the oxidative decomposition reaction is suppressed for the following reasons. The first ether compound having a LUMO at a high energy level has high reduction resistance but low oxidation resistance, and has a property of being easily subjected to oxidative decomposition at an interface between the positive electrode and the non-aqueous electrolyte. On the other hand, the fluorinated site of the second ether compound tends to interact with the transition metal on the surface of the positive electrode material. It is considered that the oxidative decomposition reaction of the first ether compound is suppressed by such an interaction.

Examples of the second ether compound include 1,1,2,2-tetrafluoroethyl 2,2,2-trifluoroethyl ether and 1,1,2,2-tetrafluoroethyl 2,2,3,3-tetrafluoropropyl ether. The second ether compound may be used singly or in combination of two or more kinds.

The proportion of the total amount of the first ether compound and the second ether compound in the solvent is 80 volume % or more, and preferably 90 volume % or more, and more preferably 95 volume % or more. In this case, an effect of using the first ether compound and the second ether compound in combination is easily and remarkably exhibited, and a non-aqueous electrolyte secondary battery having excellent cycle characteristics can be obtained.

The volume ratio: V1/V2 of the volume V1 of the first ether compound to the volume V2 of the second ether compound in the solvent is preferably from 1/0.5 to 1/4, and more preferably from 1/0.5 to 1/2. When the volume ratio V1/V2 is within the above range, the solubility of the lithium salt in the solvent increases, and the side reactions between lithium metals and the non-aqueous electrolyte tends to be suppressed. Also, since the charge and discharge reactions become more uniform and the formation of a dendritic lithium metal is inhibited, the volume change due to expansion and contraction of the electrode can be suppressed. Therefore, cycle characteristics of the lithium metal secondary battery is improved.

The volume ratio V1/V2 is appropriately adjusted according to the fluorination rate of the second ether compound and the like.

Note that, in the present disclosure, the proportion of each solvent in the entire solvent is defined as a proportion on a volume basis (volume %) at 25° C.

The solvent of the non-aqueous electrolyte may include a solvent other than the first ether compound and the second ether compound, and may include, for example, an ester, an ether, a nitrile, an amide, or a halogen substitute thereof. The non-aqueous electrolyte may include one kind of the other solvent, and may include two or more kinds thereof. The halogen substitute has a structure in which at least one hydrogen atom is substituted with a halogen atom. Examples of the halogen atom include a fluorine atom, a chlorine atom, a bromine atom, and/or an iodine atom and the like. However, the halogen substitute of the ether does not have a fluorine atom and has a halogen atom other than a fluorine atom.

Examples of an ester include a carbonic acid ester and a carboxylic acid ester. Examples of a cyclic carbonic acid ester include ethylene carbonate, propylene carbonate, butylene carbonate, and fluoroethylene carbonate. Examples of a chain carbonic acid ester include dimethyl carbonate, ethyl methyl carbonate, diethyl carbonate, methyl propyl carbonate, ethyl propyl carbonate, and methyl isopropyl carbonate. Examples of a cyclic carboxylic acid ester include γ-butyrolactone and γ-valerolactone. Examples of a chain carboxylic acid ester include methyl acetate, ethyl acetate, propyl acetate, methyl propionate, ethyl propionate, and methyl fluoropropionate.

Examples of an ether includes a cyclic ether and a chain ether. Examples of a cyclic ether include 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ether. As a chain ether, a chain ether other than the first ether compound can be used. The examples include diethyl ether, dipropyl ether, dibutyl ether, dihexyl ether, ethylvinyl ether, butyl vinyl ether, methylphenyl ether, ethylphenyl ether, butylphenyl ether, pentylphenyl ether, methoxytoluene, benzylethyl ether, diphenyl ether, dibenzyl ether, o-dimethoxybenzene, 1,1-dimethoxymethane, 1,1-diethoxyethane, and the like.

Examples of a nitrile include acetonitrile, propionitrile, and benzonitrile. Examples of an amide include dimethylformamide and dimethylacetamide.

However, solvents used in the non-aqueous electrolyte is not limited thereto.

### (Electrolytic Salt)

In a non-aqueous electrolyte secondary battery according to an embodiment of the present invention, a lithium salt is used as an electrolytic salt contained in a non-aqueous electrolyte. Lithium salt is a salt of a lithium ion and an anion. In the non-aqueous electrolyte, the lithium salt is dissolved in a solvent. Therefore, in the non-aqueous electrolyte, usually, a lithium salt is contained in a state of being dissociated into lithium ions and anions.

As the lithium salt, known ones utilized in a non-aqueous electrolyte of a lithium metal secondary battery can be used. Examples of the anion include BF₄⁻, ClO₄⁻, PF₆⁻, AsF₆⁻, SbF₆⁻, AlCl₄⁻, SCN⁻, CF₃SO₃⁻, CF₃CO₂⁻, anions of imide, anions of oxalate, and the like. The non-aqueous electrolyte may contain one kind of these anions, and may contain two or more kinds thereof.

Anions of imide include N(SO₂CₘF₂ₘ₊₁)(SO₂CₙF₂ₙ₊₁)⁻, where m and n are independently integers of zero or more, and the like. The m and n may be 0 to 3, and may be 0, 1, or 2, respectively. The anions of imide may be N(SO₂CF₃)₂⁻, N(SO₂C₂F₅)₂⁻, N(SO₂F)₂⁻. Incidentally, N(SO₂F)₂⁻ is denoted as FSI⁻, and lithium bis(fluorosulfonyl)mide which is a salt of a lithium ion and FSI⁻ is sometimes represented as LiFSI.

Anions of oxalate may contain boron and/or phosphorus. The anions of oxalate include bis(oxalato)borate anion, BF₂(C₂O₄)⁻, PF₄(C₂O₄)⁻, PF₂(C₂O₄)₂⁻, and the like.

In view of inhibiting a lithium metal from depositing in a dendritic form, a non-aqueous electrolyte may contain at least one selected from the group consisting of anions of imides, PF₆⁻ and anions of oxalate. When a non-aqueous electrolyte containing an anion of oxalate is used, lithium metals tend to be uniformly precipitated in a fine particulate form due to the interaction between the anion of oxalate and lithium. Therefore, the occurrence of uneven charge and discharge reactions associated with local deposition of a lithium metal can be inhibited. In order to accelerate the formation of uniformly deposited fine particulate lithium metals, bis(oxalato)borate anion and/or BF₂(C₂O₄)⁻ may be used. An anion of oxalate may be combined with other anions. Other anions may be PF₆⁻, and/or anions of imide.

Among them, it is preferable to use LiFSI because a uniform SEI film can be formed on the negative electrode and deposition of a dendritic lithium metal can be effectively suppressed. It is also preferable to use lithium hexafluorophosphate (LiPF₆) which is a salt of a lithium ion and PF₆⁻, along with LiFSI in order to lower the viscosity of the non-aqueous electrolyte and to reduce the cost.

When the electrolytic salt includes LiFSI and LiPF₆, the ratio: M1/M2 of the molar concentration M1 of LiFSI to the molar concentration M2 of LiPF₆ in the non-aqueous electrolyte is preferably from 1/0.5 to 1/9, and more preferably from 1/2 to 1/5. In this case, a more uniform SEI film is formed, and uniform charge and discharge reactions tend to occur.

Further, it is preferred that the electrolytic salt includes lithium difluorobis(oxalato)borate (LiFOB) which is a salt of a lithium ion and BF₂(C₂O₄)⁻. In this case, it seems possible to suppress the occurrence of uneven charge and discharge reactions associated with local deposition of lithium metals, because lithium metals are prone to deposit uniformly in a fine particulate form.

The concentration of the electrolytic salt in the non-aqueous electrolyte is preferably from 0.8 mol/L to 3 mol/L, more preferably from 0.8 mol/L to 1.8 mol/L. When the concentration of the electrolytic salt is in such a range, high lithium-ion conductivity of the non-aqueous electrolyte can be secured. Even when the concentration of the electrolytic salt in the non-aqueous electrolyte is in such a range, the lithium salt can be easily dissolved in the solvent by using the first ether compound. Further, by the second ether compound, the number of solvent molecules solvated with lithium ions can be reduced, and the charge and discharge reactions can efficiently proceed.

Here, the concentration of the electrolytic salt is the sum of the concentration of dissociated lithium salt and the concentration of undissociated lithium salt. The concentration of anions in the non-aqueous electrolyte may be in the range of the concentration of the lithium salt described above.

### (Additives)

The non-aqueous electrolyte may include an additive. The additive may have an action of forming a film on the negative electrode. By forming the film derived from the additive on the negative electrode, the charge and discharge reactions tend to proceed more uniformly, and also, the formation of a dendritic lithium metal tends to be suppressed. Therefore, the effect of suppressing the volume change of the negative electrode associated with charging and discharging is further enhanced, which can further suppress the deterioration of cycle characteristics. Examples of such an additive include vinylene carbonate, fluoroethylene carbonate, and vinyl ethyl carbonate. Additive may be used singly or in combination of two or more kinds.

A lithium metal secondary battery includes a positive electrode, a negative electrode and a non-aqueous electrolyte. A separator is usually placed between the positive and negative electrodes. Hereinafter, configurations of a lithium metal secondary battery will be described with reference to the drawings.

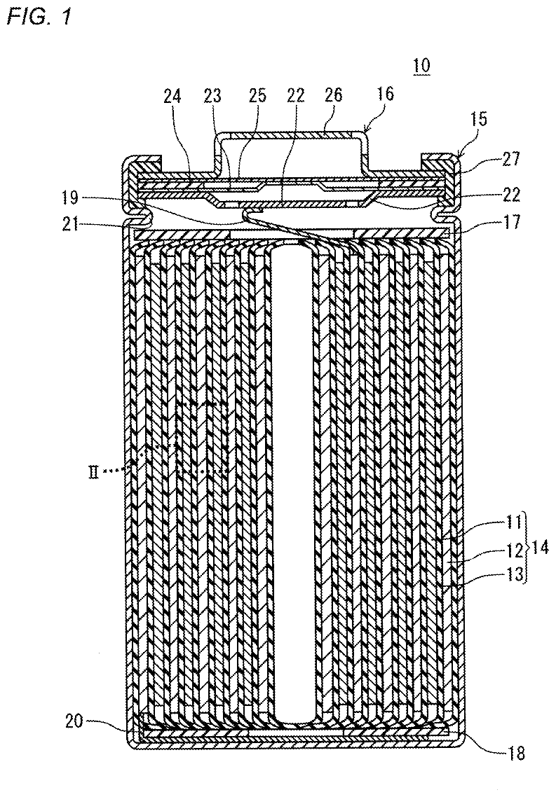

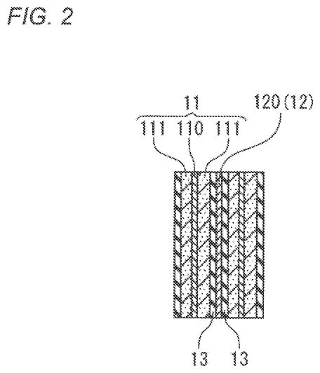

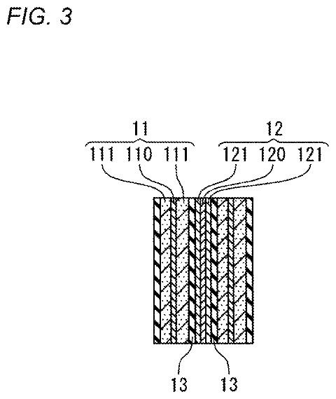

FIG. 1 is a longitudinal cross-sectional view schematically illustrating a lithium metal secondary battery according to one embodiment of the present disclosure. FIGS. 2 and 3 are enlarged cross-sectional views schematically showing the region II of FIG. 1.

Lithium metal secondary battery 10 is a cylindrical battery including a cylindrical battery case and wound electrode group 14 and a non-aqueous electrolyte which is not shown housed in a battery case. The battery case includes case body 15 which is a bottomed cylindrical metal container, and sealing body 16 for sealing the opening of case body 15. Gasket 27 is placed between case body 15 and sealing body 16, which ensures the airtightness of the battery case. In case body 15, at both ends of the winding axis direction of electrode group 14, insulating plates 17 and 18 are respectively disposed.

Case body 15 has, for example, step 21 formed by partially pressing the lateral wall of case body 15 from the outside. Step 21 may be formed, on the side wall of case body 15, along the circumferential direction of case body 15 in an annular shape. In this case, sealing body 16 is supported by step 21 on the side of the opening.

Sealing body 16 includes filter 22, lower valve body 23, insulating member 24, upper valve body 25 and cap 26. In sealing body 16, these members are laminated in this order. Sealing body 16 is attached to the opening of case body 15 such that cap 26 is located outside case body 15 and filter 22 is located inside case body 15. Each of the above components constituting sealing body 16 is, for example, a disc or ring shape. Each member except insulating member 24 is electrically connected to each other.

Electrode group 14 has positive electrode 11, negative electrode 12 and separator 13. Positive electrode 11, negative electrode 12 and separator 13 are all band-like. As the width direction of the band-like shaped positive electrode 11 and negative electrode 12 is parallel to the winding axis, positive electrode 11 and negative electrode 12 are wound spirally with separator 13 interposed between these electrodes. In a cross section perpendicular to the winding axis of electrode group 14, positive electrode 11 and negative electrode 12 are in a state in which separator 13 is interposed between these electrodes and these are alternately laminated in the radial direction of electrode group 14.

Positive electrode 11 is electrically connected to cap 26 which also serves as a positive electrode terminal via positive electrode lead 19. One end of positive electrode lead 19, for example, is connected to the vicinity of the center in the longitudinal direction of positive electrode 11. Positive electrode lead 19 extends from positive electrode 11 through a through hole (not shown) formed in insulating plate 17 to filter 22. The other end of positive electrode lead 19 is welded to the surface of electrode group 14 side of filter 22.

Negative electrode 12 is electrically connected to case body 15 which also serves as a negative electrode terminal via negative electrode lead 20. One end of negative electrode lead 20 is connected, for example, to the end of negative electrode 12 in the longitudinal direction, and the other end is welded to the inner bottom of case body 15.

As shown in FIG. 2, positive electrode 11 includes positive electrode current collector 110 and positive electrode mixture layers 111 disposed on both surfaces of positive electrode current collector 110. Negative electrode 12 includes negative current collector 120. FIG. 2 shows a cross-section in a fully discharged state, and FIG. 3 shows a cross-section in a charged state. In negative electrode 12 of lithium metal secondary battery 10, lithium metal 121 is deposited by charging, and the deposited lithium metal 121 is dissolved in the non-aqueous electrolyte by discharging.

Configurations other than the non-aqueous electrolyte of a lithium metal secondary battery is discussed more specifically below. As for configurations other than the non-aqueous electrolyte, known ones used in lithium metal secondary batteries can be used without any particular limitation.

### [Positive Electrode]

Positive electrode 11 includes, for example, positive electrode current collector 110 and positive electrode mixture layer 111 formed on positive electrode current collector 110. Positive electrode mixture layer 111 may be formed on both surfaces of positive electrode current collector 110. Positive electrode mixture layer 111 may be formed on one surface of positive electrode current collector 110. For example, in a region of positive electrode collector 110 connecting to positive electrode lead 19 and/or in a region of not opposing negative electrode 12, positive electrode mixture layer 111 may be formed only on one surface.

Positive electrode mixture layer 111 contains a positive electrode active material as an essential component, and may include a conductive material and/or a binder as an optional component. Positive electrode mixture layer 111 may contain an additive, if necessary. A conductive carbon material may be placed between positive electrode current collector 110 and positive electrode mixture layer 111 as appropriate.

Positive electrode 11 is obtained, for example, by coating a slurry containing constituent components of positive electrode mixture layer 111 and a dispersion medium on the surface of positive electrode current collector 110, drying the coating film, and then rolling the film. Examples of the dispersion medium include water and/or an organic medium. A conductive carbon material may be applied to the surface of positive electrode current collector 110 as appropriate.

Examples of the positive electrode active material include a material that absorbs and releases lithium ions. Examples of the positive electrode active material include a lithium-containing transition metal oxide, a transition metal fluoride, a polyanion, a fluorinated polyanion, and/or a transition metal sulfide. In view of the high average discharge voltage and cost advantage, the positive electrode active material may be a lithium-containing transition metal oxide.

As the transition metal element contained in the lithium-containing transition metal oxide, Sc, Ti, V, Cr, Mn, Fe, Co, Ni, Cu, Y, Zr, W and the like are cited. The lithium-containing transition metal oxide may contain one kind of transition metal element, and may contain two or more kinds thereof. The transition metal element may include Co, Ni, and/or Mn. The lithium-containing transition metal oxide may optionally include one or two or more typical metal elements. As the typical metal element, Mg, Al, Ca, Zn, Ga, Ge, Sn, Sb, Pb, Bi, and the like are cited. The typical metal element may be Al, or the like.

The positive electrode active material is not particularly limited in its crystal structure, but a positive electrode active material having a crystal structure belonging to the space group R-3m may be used. Such positive electrode active materials are less prone to deterioration in the above non-aqueous electrolyte because of the relatively small expansion and contraction of the lattice associated with charging and discharging, thus providing excellent cycle characteristics. The positive electrode active material with a crystal structure belonging to the space group R-3m may include, for example, Ni, Co, Mn, and/or Al. In such a positive active material, the proportion of Ni to the sum number of the atoms of Ni, Co, Mn, and Al may be 50 atom % or more. For example, when the positive electrode active material contains Ni, Co, and Al, the proportion of Ni may be 50 atom % or more, and may be 80 atom % or more. When the positive active material contains Ni, Co, and Mn, the proportion of Ni may be 50 atom % or more.

Examples of the conductive material include, for example, carbon materials. Examples of the carbon material include carbon black, carbon nanotubes, and graphite. Examples of carbon black include acetylene black and Ketjen black. Positive electrode mixture layer 111 may include one or two or more of the conductive materials. At least one selected from these carbon materials may be used as the conductive carbon material to be present between positive electrode current collector 110 and positive electrode mixture layer 111.

Examples of the binder include a fluororesin, polyacrylonitrile, a polyimide resin, an acrylic resin, a polyolefin resin, and a rubbery polymer. Examples of the fluororesin include polytetrafluoroethylene and polyvinylidene fluoride. Positive electrode mixture layer 111 may include one kind of the binders, and may include two or more kinds thereof.

The material of positive electrode current collector 110 includes, for example, a metal material containing Al, Ti, Fe or the like. The metal material may be Al, Al alloy, Ti, Ti alloy, Fe alloy or the like. The Fe alloy may be stainless steel or the like called SUS. As positive electrode current collector 110, foils, films and the like are mentioned. Positive electrode current collector 110 may be porous. For example, a metal mesh or the like may be used as positive electrode current collector 110.

### [Negative Electrode]

In negative electrode 12 of a lithium metal secondary battery 10, lithium metal 121 is deposited by charging. More specifically, lithium ions released from the positive electrode to the non-aqueous electrolyte receive electrons on negative electrode 12 by charging and become lithium metal 121, which is deposited on negative electrode 12. Lithium metal 121 deposited on negative electrode 12 is dissolved as lithium ions in the non-aqueous electrolyte by discharging.

Negative electrode 12 includes negative electrode current collector 120. Negative electrode current collector 120 is usually composed of a conductive sheet. The conductive sheet may be formed of a lithium metal or a lithium alloy, and may be formed of a conductive material other than a lithium metal and a lithium alloy. The conductive material may be a metal material such as metals and alloys. The metal material may be a material that does not react with lithium. More specifically, it may be a material which does not form any alloys and intermetallic compounds with lithium. Such metal materials include, for example, copper, nickel, iron, and alloys containing any of these metal elements. As the alloy, copper alloy, SUS or the like may be used. The metal material may be copper and/or a copper alloy from the viewpoint of having high electrical conductivity and easily ensuring high capacity and high charge and discharge efficiency. The Conductive sheet may include one or more of these conductive materials.

As the conductive sheet, a foil, a film or the like is utilized. The conductive sheet may be porous. From the viewpoint of easily ensuring high conductivity, the conductive sheet may be a metal foil, or a metal foil containing copper. Such metal foils may be a copper foil or a copper alloy foil. The content of copper in the metal foil may be 50 mass % or more, and may be 80 mass % or more. Metal foils may include, in particular, copper foils containing substantially only copper as a metal element.

Note that negative electrode 12 may contain only a negative electrode current collector 120 in a fully discharged state of the lithium metal secondary battery 10. In this case it is easy to secure a high volume-energy density. In this case, negative electrode current collector 120 may be made of a material that does not react with lithium. In view of ensuring high charge and discharge efficiency, in a fully discharged state, negative electrode 12 may include negative electrode current collector 120 and a negative electrode active material layer disposed on the surface of negative electrode current collector 120. In assembling the battery, only negative electrode current collector 120 may be used as negative electrode 12, or negative electrode 12 which includes the negative electrode active material layer and negative electrode current collector 120 may be used.

Examples of the negative electrode active material contained in the negative electrode active material layer include a lithium metal, a lithium alloy, and a material which reversibly absorbs and releases lithium ions. As the negative electrode active material, a negative electrode active material used in lithium-ion batteries may be used. Lithium alloys include, for example, lithium aluminum alloys. Examples of the material which reversibly absorbs and releases lithium ions include a carbon material and an alloy-based material. Examples of the carbon material include a graphite material, soft carbon, hard carbon, and/or an amorphous carbon. Examples of the alloy-based material include a material containing silicon and/or tin. Examples of the alloy-based material include a silicon simple substance, a silicon alloy, a silicon compound, a tin simple substance, a tin alloy, and/or a tin compound. Examples of each of the silicon compound and the tin compound include an oxide, and/or a nitride and the like.

The negative electrode active material layer may be formed by depositing a negative electrode active material on the surface of negative electrode current collector 120 using a vapor phase method such as electrodeposition or vapor deposition. Further, the negative electrode active material layer may be formed by coating a negative electrode mixture containing a negative electrode active material, a binder, and, if necessary, other components on the surface of negative electrode current collector 120. Other components include conductive agents, thickeners, and/or additives and the like.

The thickness of the negative electrode active material layer is not limited, but is 30 μm or more and 300 μm or less, for example, in a fully discharged state of a lithium metal secondary battery. The thickness of the negative electrode current collector 120 is, for example, 5 μm or more and 20 μm or less.

In the present disclosure, the fully discharged state of the lithium metal secondary battery refers to a state in which the battery is discharged until a state of charge (SOC: State of Charge) of 0.05×C or less, when the rated capacity of the battery is C. For example, it refers to a condition in which the battery is discharged to the lower limit voltage at a constant current of 0.05 C. The lower limit voltage is, for example, 2.5 V.

Negative electrode 12 may further include a protective layer. The protective layer may be formed on the surface of negative electrode current collector 120, and may be formed on the surface of the negative electrode active material layer when negative electrode 12 has a negative electrode active material layer. The protective layer has an effect of making reactions on the electrode surface more uniform, and lithium metal 121 tends to be more uniformly deposited on the negative electrode. The protective layer may be made of, for example, an organic substance, and/or an inorganic substance or the like. As for these materials, a material which does not inhibit lithium-ion conductivity is used. Examples of the organic substance include a polymer having lithium-ion conductivity and the like. Examples of such a polymer include polyethylene oxide, and/or polymethyl methacrylate and the like. Examples of the inorganic substance include ceramics, solid electrolytes, and the like. The ceramics include SiO₂, Al₂O₃, and/or MgO.

The solid electrolyte constituting the protective layer is not particularly limited, and examples thereof include a sulfide-based solid electrolyte, a phosphoric acid-based solid electrolyte, a perovskite-based solid electrolyte, and/or a garnet-based solid electrolyte. Of these, a sulfide-based solid electrolyte and/or a phosphoric acid-based solid electrolyte may be used because of its relatively low cost and easy availability.

The sulfide-based solid electrolyte is not particularly limited as long as it contains a sulfur component and has lithium-ion conductivity. The sulfide-based solid electrolyte may include, for example, S, Li, and a third element. The third element may include at least one selected from the group consisting of, for example, P, Ge, B, Si, I, Al, Ga, and As. Specifically, Li₂S—P₂S₅, 70Li₂S-30P₂S₅, 80Li₂S-20P₂S₅, Li₂S—Si₂, LiGe_{0.25}P_{0.75}S₄ and the like can be mentioned as the sulfide-based solid electrolyte.

The phosphoric acid-based solid electrolyte is not particularly limited as long as it contains a phosphoric acid component and has lithium-ion conductivity. The phosphate-based solid electrolyte may include, for example, Li_{1-X}Al_{X}Ti_{2-X}(PO₄)₃, such as Li_{1.5}Al_{1.5}Ti_{1.5}(PO₄)₃, and Li_{1-X}Al_{X}Ge_{2-X}(PO₄)₃. The coefficient X of Al may be, for example, 0<X<2 and 0≤X≤1.

### [Separator]

Porous sheets with ion permeability and insulation property are used for separator 13. Examples of the porous sheet include a microporous film, a woven fabric, and a nonwoven fabric. The material of the separator is not particularly limited, but may be a polymer material. Examples of the polymer material include an olefin resin, a polyamide resin, cellulose, and the like. Examples of the olefin resin include polyethylene, polypropylene, an olefin copolymer containing at least one of ethylene and propylene as a monomer unit. Separator 13 may optionally include an additive. Examples of the additive include an inorganic filler and the like.

Separator 13 may include a plurality of layers having different morphologies and/or compositions. Such separator 13 may be, for example, a laminate of a polyethylene microporous film and a polypropylene microporous film, and a laminate of a nonwoven fabric containing celluose fibers and a nonwoven fabric containing thermoplastic resin fibers. Separator 13 of a microporous film, a woven fabric, a nonwoven fabric, or the like with a coating film of a polyamide resin formed on the surface thereof may be used. Since such separator 13 has a high durability, even when pressure is applied in contact with a plurality of convex portions, damages are suppressed. Also, in view of ensuring heat resistance and/or strength, separator 13 may have a layer containing an inorganic filler on the opposing side with positive electrode 11 and/or opposing side with negative electrode 12.

### [Others]

Between negative electrode 12 and separator 13, a spacer can also be provided so that a space for accommodating lithium metal 121 is secured. As described above, in lithium metal secondary battery 10, the volume change of negative electrode 12 with charging and discharging is particularly remarkable. When negative electrode 12 becomes larger at the time of charging, electrode group 14 including positive electrode 11 and negative electrode 12 can expand. Due to the stresses caused by expansion, the electrodes may be cracked or the electrodes may be cut. The spacer makes it easier to suppress the damage of such electrodes. The spacer may be provided not only between negative electrode 12 and separator 13, but also between positive electrode 11 and separator 13.

As the spacer, a known material can be used without any particular limitation. For example, by using negative electrode current collector 120 with a first surface and a second surface opposite to the first surface and with a plurality of convexes projecting from each surface, a spacer can be provided between negative electrode 12 and separator 13.

In the illustrated example, a cylindrical lithium metal secondary battery having a cylindrical battery case has been described, but the lithium metal secondary battery according to the present disclosure is not limited to this case. The lithium metal secondary battery according to the present disclosure may also be applied, for example, to a square battery with a square battery case, a laminated battery with a resin external package such as an aluminum laminated sheet or the like. Also, the electrode group is not limited to the wound type and may be a stack type electrode group in which, for example, a plurality of positive electrodes and a plurality of negative electrodes are alternately laminated such that a separator is interposed between each positive electrode and each negative electrode.

Generally, in a lithium metal secondary battery using the wound type electrode group, cracks may be produced in the electrode, or the electrode may be cut, due to the stress caused by the expansion of the negative electrode with charging. Further, even in a lithium metal secondary battery using the stack type electrode group, because the expansion of the negative electrode with charging is large, the thickness of the battery is greatly increased. However, in the lithium metal secondary battery according to the present disclosure, by using a non-aqueous electrolyte containing the first ether compound and the second ether compound, expansion of the negative electrode can be suppressed. Therefore, even when any of the wound type electrode group and the stack type electrode group is used, it is possible to suppress the deterioration of the battery characteristics including cycle characteristics due to the expansion of the negative electrode.

### EXAMPLES

Herein, lithium metal secondary batteries according to the present disclosure is specifically explained based on examples and comparative examples. The present disclosure is not limited to the following examples.

A lithium metal secondary battery having the structure shown in FIG. 1 was produced by the following procedure.

### (1) Preparation of Positive Electrode 11

A positive electrode active material, acetylene black as a conductive material, and polyvinylidene fluoride as a binder were mixed in a mass ratio of 95:2.5:2.5. A positive electrode mixture slurry was prepared by adding an appropriate amount of N-methyl-2-pyrrolidone as a dispersion medium to the mixture and stirring the mixture. As the positive electrode active material, a lithium-containing transition-metal oxide containing Ni, Co and Al and having a crystal structure belonging to the space group R-3m was used.

The positive electrode mixture slurry was applied on both surfaces of an aluminum foil as positive electrode current collector 110 and dried. The dried film was compressed in the thickness direction using rollers. The resulting laminate was cut to a predetermined electrode size to produce positive electrode 11 having positive electrode mixture layers 111 on both surfaces of positive electrode current collector 110. On a part of positive electrode 11, an exposed portion of positive electrode current collector 110 without positive electrode mixture layer 111 was formed. To the exposed portion of positive electrode current collector 110, one end of aluminum positive electrode lead 19 was attached by welding.

### (2) Preparation of Negative Electrode 12

An electrolytic copper foil having a thickness of 10 μm was cut to a predetermined electrode size to form negative electrode current collector 120. This negative electrode current collector 120 was used as negative electrode 12 for fabrication of the battery. One end of negative electrode lead 20 made of nickel was attached to the negative electrode current collector 120 by welding.

### (3) Preparation of Non-Aqueous Electrolyte

In the solvent shown in Table 1, a lithium salt was dissolved so as to have a predetermined concentration to prepare a liquid non-aqueous electrolyte.

### (4) Fabrication of Battery

In an inert gas atmosphere, positive electrode 11 obtained in the above (1) and negative electrode 12 obtained in the above (2) were laminated with a microporous film made of polyethylene as separator 13 interposed therebetween. More specifically, positive electrode 11, separator 13 and negative electrode 12 were laminated in this order. The resulting laminate was wound in a spiral shape to prepared electrode group 14. The obtained electrode group 14 was housed in a bag-shaped external package formed of a laminate sheet including an aluminum layer, and, after injecting the non-aqueous electrolyte, the external package was sealed. In this way, a lithium metal secondary battery was fabricated.

### (5) Evaluation

The resulting lithium-metal secondary battery was subjected to a charge and discharge test with the following procedures to evaluate the cycle characteristics.

First, in a 25° C. condition, the lithium metal secondary battery was charged by the following conditions, followed by a 20-minute rest period, and discharged under the following condition.

### (Charge)

At the current of 0.1 It, a constant-current charging was performed until the battery voltage became 4.3 V, and then a constant-voltage charging was performed until the current value became 0.01 It at a voltage of 4.3 V.

### (Discharge)

Constant-current discharging was performed until the battery voltage became 2.5 V at a current of 0.1 It.

The above charging and discharging taken as one cycle, a charge and discharge test of 50 cycles was performed. Discharge capacity measured at the first cycle was used as the initial discharge capacity. The ratio of the discharge capacity of the 50th cycle to the initial discharge capacity was determined as the capacity-maintenance ratio (%), and it was used as an index of the cycle characteristics.

### Example 1

1,2-Dimethoxyethane (DME) was mixed with 1,1,2,2-tetrafluoroethyl 2,2,2-trifluoroethyl ether (CHF₂(CF₂OCH₂)CF₃: fluorination rate: 70%, FE-1) so that the volume ratio V1/V2 of volume V1 and volume V2 of each was 1/2 and used as a solvent. In the obtained solvent, lithium bis(fluorosulfonyl)imide (LiFSI) was dissolved so as to have a concentration of 1 mol/L to prepare a non-aqueous electrolyte. Evaluation of the fabricated lithium metal secondary battery was performed according to (4) and (5) above.

### Example 2

A non-aqueous electrolyte was prepared in the same manner as in Example 1, except that 1,2-diethoxyethane (DEE) was used instead of DME, and evaluation of the prepared lithium metal secondary battery was performed.

### Example 3

A non-aqueous electrolyte was prepared in the same manner as in Example 1, except that 1,1,2,2-tetrafluoroethyl 2,2,3,3-tetrafluoropropyl ether (CHF₂(CF₂OCH₂)C₂HF₄: fluorination rate: 67%, FE-2) was used in place of FE-1, and the fabricated lithium-metal secondary battery was evaluated.

### Example 4

A non-aqueous electrolyte was prepared in the same manner as in Example 1, except that LiFSI was dissolved in the non-aqueous electrolyte to have a concentration of 1 mol/L and lithium difluorobis(oxalate)borate (LiBF₂(C₂O₄)₂, LiFOB) to have a concentration of 0.1 mol/L, and the fabricated lithium-metal secondary battery was evaluated.

### Example 5

A non-aqueous electrolyte was prepared in the same manner as in Example 1, except that LiFSI was dissolved in the non-aqueous electrolyte to have a concentration of 0.33 mol/L and lithium hexafluorophosphate (LiPF₆) to have a concentration of 0.67 mol/L, and the fabricated lithium-metal secondary battery was evaluated.

### Comparative Example 1

A non-aqueous electrolyte was prepared in the same manner as in Example 1, except that all of the solvent was DME without using FE-1, and the fabricated lithium-metal secondary battery was evaluated.

### Comparative Example 2

A non-aqueous electrolyte was prepared in the same manner as in Example 1, except that all of the solvent was FE-1 without using DME, and the fabricated lithium-metal secondary battery was evaluated.

### Comparative Example 3

A non-aqueous electrolyte was prepared in the same manner as in Example 1, except that CF₃CH₂OCH₂CH₂OCH₂CF₃ (fluorination rate: 43%, FE-3) was used in place of FE-1, and the fabricated lithium-metal secondary battery was evaluated.

### Comparative Example 4

A non-aqueous electrolyte was prepared in the same manner as in Example 1, except that instead of FE-1, bis(2,2,2-trifluoroethyl)carbonate (CF₃CH₂O(CO)OCH₂CF₃: fluorination rate: 60%, FC-1) was used, and the fabricated lithium-metal secondary battery was evaluated.

### Comparative Example 5

A non-aqueous electrolyte was prepared in the same manner as in Example 1, except that dimethyl carbonate (DMC) was used instead of DME, and the fabricated lithium-metal secondary battery was evaluated.

### Comparative Example 6

A non-aqueous electrolyte was prepared in the same manner as in Example 1, except that methyl acrylate (MA) was used instead of DME, and the fabricated lithium-metal secondary battery was evaluated.

### Comparative Example 7

A non-aqueous electrolyte was prepared in the same manner as in Example 1, except that triethyl phosphate (TEP) was used instead of DME, and the fabricated lithium-metal secondary battery was evaluated.

### Comparative Example 8 and Comparative Example 9

Batteries were prepared and evaluated in the same manner as in Example 1 and Comparative Example 5, except that a negative electrode containing graphite in an amount corresponding to sufficiently large capacity with respect to the positive electrode was used as the negative electrode active material.

The negative electrode was produced as follows.

Graphite as a negative electrode active material and polyvinylidene fluoride as a binder were mixed at a mass ratio of 95:5. A negative electrode mixture slurry was prepared by adding an appropriate amount of N-methyl-2-pyrrolidone as a dispersion medium to the mixture and stirring the mixture.

The negative electrode mixture slurry was applied on both surfaces of a copper foil as a negative electrode current collector and dried. The dry film was compressed in the thickness direction using rollers. The resulting laminate was cut to a predetermined electrode size to produce a negative electrode including negative electrode mixture layers on both surfaces of the negative electrode current collector. On a part of the negative electrode, an exposed portion of the negative electrode current collector without the negative electrode material layer was formed. One end of a negative electrode lead made of nickel was attached by welding to the exposed portion of the negative current collector.

The results of Examples 1 to 5 and Comparative Examples 1 to 9 are shown in Table 1.

TABLE 1

| | Non-aqueous electrolyte | | | | | | | | |
|---|---|---|---|---|---|---|---|---|---|
| | Solvent | | | | | Electrolytic salt | | | |
| | Fast ether | Second ether | Fluorination | Other | Fluorination rate | | Concentration | Negative | Capacity-maintenance |
| | compound | compound | rate (%) | solvent | (%) | Lithium salt | (mol/L) | electrode | ratio at 50th cycle (%) |
| Ex.1 | DME | FE-1 | 70 | — | — | LiFSI | 1 | Li metal | 85.7 |
| Ex.2 | DEE | FE-1 | 70 | — | — | LiFSI | 1 | Li metal | 82.7 |
| Ex.3 | DME | FE-2 | 67 | — | — | LiFSI | 1 | Li metal | 84.6 |
| Ex.4 | DME | FE-1 | 70 | — | — | LiFSI | 1 | Li metal | 86.3 |
| | | | | | | LiFOB | 0.1 | | |
| Ex.5 | DME | FE-1 | 70 | — | — | LiFSI | 0.33 | Li metal | 82.5 |
| | | | | | | LiPF₆ | 0.67 | | |
| Com. Ex. 1 | DME | — | — | — | — | LiFSI | 1 | Li metal | 39.6 |
| Com. Ex. 2 | — | FE-1 | 70 | — | — | LiFSI | 1 | Li metal | Unable to |
| | | | | | | | | | change/discharge |
| Com. Ex. 3 | DME | — | — | FE-3 | 43 | LiFSI | 1 | Li metal | 70.7 |
| Com. Ex. 4 | DME | — | — | FC-1 | 60 | LiFSI | 1 | Li metal | 20.1 |
| Com. Ex. 5 | — | FE-1 | 70 | DMC | — | LiFSI | 1 | Li metal | 63.7 |
| Com. Ex. 6 | — | FE-1 | 70 | MA | — | LiFSI | 1 | Li metal | 38.1 |
| Com. Ex. 7 | — | FE-1 | 70 | TEP | — | LiFSI | 1 | Li metal | 56.1 |
| Com. Ex. 8 | DME | FE-1 | 70 | — | — | LiFSI | 1 | Graphite | 92.2 |
| Com. Ex. 9 | — | FE-1 | 70 | DMC | — | LiFSI | 1 | Graphite | 98.6 |

As shown in Table 1, in the lithium metal secondary batteries prepared in Examples 1 to 5 in which the first ether compound and the second ether compound were used as the solvent for the non-aqueous electrolyte, a high capacity-maintenance ratio could be obtained even after 50 cycles.

On the other hand, in Comparative Example 1 in which the second ether compound was not used, the capacity-maintenance ratio after 50 cycles became low. This is considered to be due to the fact that the solvation of the first ether compound with lithium ions became large and charge and discharge reactions became uneven. In Comparative Example 2 in which the first ether compound was not used, the solubility of the lithium salt was low, and charging and discharging could not be performed.

The capacity-maintenance ratio of the lithium metal secondary battery obtained in Comparative Example 3 using a fluorinated ether compound having a fluorination rate of less than 60% was lower than that of the lithium metal secondary battery of Examples 1 to 5. As in Comparative Example 1, it is considered that the solvation of the first ether compound and the fluorinated ether compound with lithium ions was large, and charge and discharge reactions became uneven. In addition, even in Comparative Examples 4 to 7 in which the first ether compound and the second ether compound were not used in combination, the capacity-maintenance ratio became low.

As described above, when carbonate was used instead of the first ether compound as in Comparative Example 5, the capacity-maintenance ratio was lower than in Example 1 using the first ether compound. On the other hand, when the negative electrode active material was graphite, a high capacity-maintenance ratio was both obtained in Comparative Example 8 using the first ether compound and Comparative Example 9 using carbonate instead of the first ether compound. In addition, in comparative example 9, the capacity-maintenance ratio was higher than that in comparative example 8. From the above, it has been clarified that, in a lithium metal secondary battery in which charging and discharging are performed by deposition and dissolution of lithium metals in a negative electrode, unlike a case where a negative electrode active material is graphite, it is necessary to consider an influence on cycle characteristics of a solvent, particularly carbonate, and the like.

From the above results, it was confirmed that, by using the first ether compound and the second ether compound in the solvent of the non-aqueous electrolyte, cycle characteristics of the lithium metal secondary battery are improved.

Further, from the results of Example 1 and Example 5, it was found that using LiFSI rather than using LiPF₆ as a lithium salt, the capacity-maintenance ratio is higher. The use of LiFSI results in a more uniform SEI film at the negative electrode and inhibits the deposition of a dendritic lithium metal, which is likely to make the charge and discharge reactions uniform.

From the results of Example 1 and Example 4, it was clarified that the capacity-maintenance ratio was further improved by adding LiFOB. LiFOB makes lithium metals more likely to be deposited uniformly in a fine particulate form, which may further inhibit the progression of the uneven charge and discharge reactions associated with the local deposition of lithium metals.

### INDUSTRIAL APPLICABILITY

The lithium metal secondary battery according to the present disclosure is superior in cycle characteristics. Therefore, the lithium metal secondary battery according to the present disclosure is useful for various applications such as mobile phones, smartphones, electronic devices such as tablet terminals, electric cars including hybrids and plug-in hybrids, and home-use batteries combined with solar cells.

Although the invention has been described in terms of the preferred embodiments at present, such disclosure should not be interpreted in a limited manner. Various variations and modifications will certainly become apparent to those skilled in the art belonging to the present invention upon reading the above disclosure. Therefore, the scope of the accompanying claim should be interpreted as encompassing all variations and modifications without departing from the true spirit and scope of the invention.

### REFERENCE SIGNS LIST

10: Lithium metal secondary battery
11: Positive electrode
12: Negative electrode
13: Separator
14: Electrode group
15: Case body
16: Sealing body
17, 18: Insulating plate
19: Positive electrode lead
20: Negative electrode lead
21: Step
22: Filter
23: Lower valve body
24: Insulating member
25: Upper valve body
26: Cap
27: Gasket
110: Positive electrode current collector
111: Positive electrode mixture layer
120: Negative electrode current collector
121: Lithium metal

1. A non-aqueous electrolyte secondary battery comprising:
a positive electrode, a negative electrode, and a non-aqueous electrolyte with lithium-ion conductivity,
wherein, on the negative electrode, a lithium metal is deposited by charging and the lithium metal is dissolved in the non-aqueous electrolyte by discharging,
the non-aqueous electrolyte includes an electrolytic salt and a solvent,
the solvent includes
a first ether compound represented by a general formula (1):
$$R 1 \text{-} {( {OCH}_{2} {CH}_{2} )}_{n} \text{-} OR 2 ,$$
where R1 and R2 are independently an alkyl group with a carbon number of 1 to 5, and n represents 1 to 3, and
a second ether compound having a fluorination rate of 60% or more and represented by a general formula (2):
$${C}_{a 1} {H}_{b 1} {F}_{c 1} {O}_{d 1} ( {CF}_{2} {OCH}_{2} ) {C}_{a 2} {H}_{b 2} {F}_{c 2} {O}_{d 2}$$
where a1≥1, a2≥0, b1≤2a1, b2≤2a2, c1=(2a1+1)−b1, c2=(2a2+1)−b2, d1≥0, and d2≥0, and
a proportion of a total amount of the first ether compound and the second ether compound in the solvent is 80 volume % or more.

2. The non-aqueous electrolyte secondary battery according to claim 1,
wherein a volume ratio: V1/V2 of a volume V1 of the first ether compound to a volume V2 of the second ether compound in the solvent is 1/0.5 to 1/4.

3. The non-aqueous electrolyte secondary battery according to claim 1,
wherein a concentration of the electrolytic salt in the non-aqueous electrolyte is from 0.8 mol/L to 3 mol/L.

4. The non-aqueous electrolyte secondary battery according to claim 1,
wherein the electrolytic salt includes lithium bis(fluorosulfonyl)imide: LiFSI.

5. The non-aqueous electrolyte secondary battery according to claim 4,
wherein the electrolytic salt further includes lithium hexafluorophosphate: LiPF₆, and
a ratio: M1/M2 of a molar concentration M1 of LiFSI to a molar concentration M2 of LiPF₆ in the non-aqueous electrolyte is from 1/0.5 to 1/9.

6. The non-aqueous electrolyte secondary battery according to claim 1,
wherein the electrolytic salt includes lithium difluoro(oxalate)borate: LiBF₂(C₂O₄).
